(19) United States
(12) Patent Application Publication
(10) Pub. No.: US 2016/0005084 A1
(43) Pub. Date: Jan. 7, 2016

(54) SYSTEMS, METHODS, AND COMPUTER PROGRAM PRODUCTS FOR USER-SPECIFIC PRODUCT RELATED ACTIVITY

(71) Applicant: S.L.I. SYSTEMS, INC., Christchurch (NZ)

(72) Inventor: Shaun William Ryan, Beckenham (NZ)

(21) Appl. No.: 14/790,974

(22) Filed: Jul. 2, 2015

(30) Foreign Application Priority Data
Jul. 4, 2014 (NZ) 627092

(51) Int. Cl. G06Q 30/02; G06Q 10/10; H04L 29/08

(52) U.S. Cl. CPC G06Q 30/0269; H04L 67/306; G06Q 10/107; G06Q 30/0256; G06Q 30/0277

(57) ABSTRACT

A system, method, and computer program product for aggregating product related activity from across a plurality of e-commerce entities is provided. The method comprises receiving, at a product aggregation service provider, data identifying a product at an e-commerce entity connected with activity by a user; associating the product with at least one user profile maintained by the product aggregation service provider; determining the geo-location of a user device being within the vicinity of a physical store location associated with the e-commerce entity; and transmitting, to a user device of the store, at least a portion of the user profile of the user for display to a staff member of the store.

### CROSS-REFERENCE TO RELATED APPLICATION

This application claims priority to New Zealand patent Application No. 627092, which was filed Jul. 4, 2014.

### FIELD OF DISCLOSURE

The present disclosure relates to a system and method for managing user-specific product related activity—more particularly the provision of purchase recommendations based on user related activity.

### BACKGROUND OF THE DISCLOSURE

A range of techniques are known in e-commerce for producing recommendations for a user based on their online behaviour—particularly by retailers having a purchase or browsing history of a user. However, such recommendations can be diluted by making assumptions regarding the individuals associated with that behaviour.

In particular, a device or account may be shared by multiple people—particularly within a family. While an individual's behaviour may relate to their making purchases for another user (such as a gift), it is at least as likely that they are primarily interested in recommendations directed to their personal interests.

Further, an individual's activity relating to the offerings of any one e-commerce operator may be relatively limited—in turn limiting the information available to make recommendations for that user.

It is an object of the present invention to address the foregoing problems or at least to provide the public with a useful choice.

All references, including any patents or patent applications cited in this specification are hereby incorporated by reference. No admission is made that any reference constitutes prior art. The discussion of the references states what their authors assert, and the applicants reserve the right to challenge the accuracy and pertinency of the cited documents. It will be clearly understood that, although a number of prior art publications are referred to herein, this reference does not constitute an admission that any of these documents form part of the common general knowledge in the art, in New Zealand or in any other country.

Throughout this specification, the word “comprise”, or variations thereof such as “comprises” or “comprising”, will be understood to imply the inclusion of a stated element, integer or step, or group of elements integers or steps, but not the exclusion of any other element, integer or step, or group of elements, integers or steps.

Further aspects and advantages of the present invention will become apparent from the ensuing description which is given by way of example only.

### SUMMARY

According to an exemplary embodiment, there is provided a method of aggregating product related activity from across a plurality of e-commerce entities, including receiving, at a product aggregation service provider, data identifying a product at an e-commerce entity connected with activity by a user; and associating the product with a user profile maintained by the product aggregation service provider.

A method of aggregating product related activity from across a plurality of e-commerce entities, comprising: receiving, at a product aggregation service provider, data identifying a product at an e-commerce entity connected with activity by a user; associating the product with at least one user profile maintained by the product aggregation service provider; determining the geo-location of a user device being within the vicinity of a physical store location associated with the e-commerce entity; and transmitting, to a user device of the store, at least a portion of the user profile of the user for display to a staff member of the store.

An e-commerce entity should be understood to mean any entity having an online presence making details of products available—for example, a retailer, wholesaler, or manufacturer.

It should be appreciated that reference to a product may comprise either goods or services. For example, the product may be an article of clothing, a meal at a restaurant, or accommodation. Product related activity may comprise, for example, purchase of the product, or indications of approval or desire of the product.

It is envisaged that exemplary embodiments may provide a product aggregation service—particularly a purchase history aggregation service—enabling allocation of products (whether purchased or desired) from a range of e-commerce entities to individuals. This service may be structured and implemented in a number of forms, for example: forming part of a social network service, operated independently from retailers (users may establish accounts with associated user profiles as known in the art); integrating into a retailer's online store, with user accounts and profiles being specific to that retailer; operating independently from a retailer's online store, but interacting with the store to provide user specific recommendations and content—for example through an application programming interface (API); or interfacing with both retailers and existing social networking platforms.

The general structure of online social networking platforms is known in the art: individuals or entities establish representations of themselves (commonly in the form of user profiles), elect to be linked to other users of the platform in order to interact, and utilise services associated with the platform.

It should be appreciated that while various functions of embodiments of the product aggregation service may be discussed herein in the context of a social network, this is not intended to be limiting. Some functions may be implemented in other embodiments not comprising a social networking component.

It is envisaged that an individual may establish a user profile for themselves on the platform through any suitable means known in the art. The user profile may comprise, for example and without limitation, identifying information, demographic information, preferences, and contact information. The user profile may be allocated a unique identifier which may be used by the system to associate purchases and provide recommendations.

A user's home page within the system may comprise one or more of: recommendations for the user; a purchase add function (enabling the addition of a purchase to the user's account or for association with another user); purchases for the user (whether by themselves or another); a “wish list” created by the user of products they have interest in; purchases made by one or more other users connected to the user.

Where products or product summaries are displayed on a user's home page (for example within a recommendations section, wish list, or a section displaying purchases of related users), various options may be provided to manage retention or associations for the product. For example, options may be provided to add the product to purchases for the user or their wish list, remove the product from the display, or seek more information regarding the product (as discussed below).

It is also envisaged that an individual may establish a user profile for another individual, if such a profile does not already exist. In doing so, purchased products may be allocated to a user profile, and recommendations specific to that profile provided, without active participation from that individual.

In such cases, user profiles created on behalf of an individual may only be accessible by the creator until authorisation is provided. This may assist in maintaining privacy while still enabling the allocation of purchases for the various reasons discussed herein.

It is envisaged that in exemplary embodiments, e-commerce entities may establish a presence within the product aggregation service. For example, a page may be created within the exemplary social network providing one or more of: details of products sold by a retailer; frequent purchasers of the retailer's products; or contact details for retailer.

Information on the retailer's page may be tailored to the user viewing the page, for example: recommended products sold by retailer; the user's connections who are purchasers of the retailer may be prioritised for display; previous purchases from retailer; highlighting or prioritising display of products sold by the retailer which are in the user's wishlist. It is envisaged that this may comprise products available from the retailer which are identical, or equivalent, to products in the user's wishlist which have been comprised from another retailer.

It should be appreciated that this information—particularly recommendations and wishlist products—may also be displayed at a retailer's online store, i.e. not within a page managed by the purchase history aggregation service but sourcing data from the service.

For example, users visiting the website of a participating retailer may be presented with an ‘add to wish list’ feature within any page that displays a product—with that information being passed to the product aggregation service.

Similarly, pages may be established for individual products which display, for example, retailers from which the product may be purchased, related products, alternative products, or reviews of the product.

According to an exemplary embodiment, there is provided a method for displaying previous purchasers of a product on a webpage, comprising the steps of: determining previous purchasers of the product; displaying identifiers of the previous purchasers on the webpage.

In an embodiment, the method may comprise the steps of: identifying a user viewing the webpage; and determining whether the user is associated with at least one of the previous purchasers of the product, wherein displaying the identifiers comprises prioritising display of identifiers of the previous purchasers associated with the user.

The identifier may be any suitable means for identifying the individual as known in the art—for example an image or name.

It is envisaged that in embodiments in which purchasers are displayed, a user may request a review of the product from a purchaser. Such a review may be delivered to the requesting user, and/or displayed on the product page.

According to an exemplary embodiment, there is provided a method for soliciting reviews of a product, comprising the steps of: identifying at least one previous purchaser of a product displayed on a webpage; displaying an identifier of the previous purchaser on the webpage; receiving, from a user, a request for a review of the product by the previous purchaser; sending a message to the previous purchaser requesting a review of the product; receiving the review from the previous purchaser; and displaying the review.

In an embodiment, such reviews may be supplied to e-commerce entities listing the product for display—whether on a retailer page within the system, or an independently operated online presence.

It should be appreciated that pages may also be established for e-commerce entities other than retailers. By way of example, pages may be provided for manufacturers of products, displaying details of their products (such as those described above in relation to retailers), and potentially the retailers who sell them.

Receiving the data identifying the purchased product may be achieved in a variety of ways.

In an exemplary embodiment, data identifying a purchased product may be input by a user. For example, numerous actions may trigger the presentation of a form having a variety of information fields for completion.

Such information fields may comprise, for example: the name of the product or service purchased (it is envisaged that autocomplete functionality may be comprised to suggest products, which on selection may complete other information fields); purchase price, and date of purchase; URL of the page from which the product (this may enable data regarding the product to be extracted automatically); retailer (again, this may be autocompleted or suggestions made based on previous entries); details of the purchaser, and for whom the purchase was made; the relational nature of the purchased item may also be indicated (for example, where an item is purchased by one person for another, this may be indicated in the allocation of the purchase); rating/review of the product.

It should be appreciated that entry of the data may be initiated by various means. For example, a user may select the previously referred to purchase add function on their home page, or on the profile page of another user.

In another embodiment, a user may select a product displayed on any of the aforementioned user, retailer, product, or manufacturer pages, or other pages such as search, navigation or home page, and be presented with the option to indicate that they have purchased the product (or want to add it to their wish list).

In an exemplary embodiment, the purchased product data may be received in the form of a purchase confirmation message. The message may be any suitable electronic message known in the art (e.g., e-mail, text message, web browser plug-in).

It is common for a receipt of purchase to be emailed to the email account of purchaser. It is envisaged that these may be forwarded to the entity providing the recommendation service, and the data extracted accordingly. By way of example, United States Patent Application Publication No. 2009/0012824 illustrates methodology for parsing information from electronic messages and populating data fields with this information.

In an embodiment, sender and destination details of the purchase confirmation message may be used may be used to identify user profiles with which the purchased item(s) is to be associated.

For example, the email address of the purchaser may be used to identify a core user profile to associate the purchase with. Further, the email address to which the purchase confirmation message is sent may be used to identify the user profile for whom the purchase was made, or indicate how the message is to be processed. For example: “purchase@[address]” may be used to flag that the purchaser will identify the user profile to associate the purchase with at a later date; “me@[address]” for purchases to be associated with the core user profile; or “[name]@[address]” for purchases for a person other than the core user profile.

Where the system is unable to extract information from the message, the user of the core user profile may be notified and provided with an option to manually enter the data identifying the purchased item.

According to an exemplary embodiment, there is provided method for providing user-specific purchase recommendations, comprising the steps of: receiving, at a product aggregation service provider, data identifying a product connected with activity by a user at an e-commerce entity; associating the product with a user profile maintained by the product aggregation service provider; generating recommendations for the user profile based at least in part on products associated with the user profile; and outputting the recommendations to a user associated with the user profile.

It should be appreciated that various techniques exist for determining the relevance of a product to a user, and therefore provide recommendations. Embodiments of the present invention may enable these recommendations to be made on the basis of activity by, or for, an individual without being influenced by activity by the user on behalf of others.

Further, recommendations may be influenced by other factors such as: behavioural interactions with products on e-commerce entity websites, for example products or categories selected for viewing, products added to a cart, or search terms; geospatial or seasonal information, for example winter clothing may be recommended over summer clothing during colder seasons or where the user is in a colder region; or essentially any other information the user choses to share, for example app data. Check-in or travel history could influence recommendations based on places they have been, and activities/services associated with that data.

For example, a database may be compiled listing products, related products, relatedness, and popularity. Popularity may be influenced by a time decay factor—i.e. more recent purchases will be rated more highly.

An exemplary technique for providing recommendations may comprise: creating a list of products purchased for that individual; creating a relevance multiplier for each product that equates to (a decay factor)̂(time since it was purchased for them); finding related products for each purchased product, and multiplying the relatedness factor by the relevance multiplier divided by the popularity of the related product; for related products suggested multiple times, adding the scaled relatedness factor together; and ranking recommendations by the summed and scaled relatedness factor.

It is envisaged that the user may be provided with the option to express approval or otherwise of a recommendation made for them. This information may be used to further refine the user's preferences and enable the system to provide enhanced recommendations as it learns more about the user.

For the avoidance of doubt, it should be appreciated that recommendations may be presented on the site of an e-commerce entity site, not only within that operated by the product aggregation service.

There are numerous ways by which the correct user profile may be selected for determining the recommendations, or identifying connected previous purchasers. For example, where the product aggregation service is provided in a self-contained site, the user may log in to the site by any suitable means known in the art.

Similarly, where a user is logged in to an account associated with an e-commerce entity, that account may be linked to a user profile of the product aggregation service.

In another embodiment, browser identification techniques (such as cookies) may be used to identify a user profile to a retailer without requiring the user to actively log in.

Where multiple user profiles are associated with an account or device, the user may be provided the option to select the current user profile for recommendation generation or display of connected purchasers of a product. Alternatively, the system may be configured to determine the most likely user profile based on most recent online activity—particularly product activity at a participating e-commerce entity website.

Embodiments of the product aggregation service may comprise search functionality—for example across pages operated by the service. In another embodiment, data from the service may be used to supplement the searching algorithms of search functionality integrated into a retailer's online store. Recommendations determined for a user may be integrated into the search results.

In embodiments, search results returned in response to a search query may be influenced by whether a product has been purchased by others associated with the user. This may be, for example, inclusion of at least one of result associated with a purchase, or giving a higher weighting to results associated with a purchase.

According to an exemplary embodiment, there is provided method for returning search results in response to a search query, comprising the steps of: receiving a search query from a user; determining search results in response to the search query; identifying search results associated with purchases by other users associated with the user; and comprising at least one of the search results associated with purchases in a list of search results output to the user.

Where an e-commerce entity has an associated physical presence—for example a retail store—it is envisaged that data sourced from the aggregation service may be used in conjunction with user locating services to provide location specific services.

It should be appreciate that the geo-location of a user may be established using any number of techniques—for example direct determination of GPS coordinates, or in conjunction with location “check-in” services such as Foursquare™.

For example, a user may be identified as being within a retailer's store, and a user profile displayed to a staff member of the retailer. This user profile may comprise user identification details such as a profile picture, and name—enabling the staff member to address the user by name and personalise their in-store experience.

The user profile may also comprise details of products available from the retailer which are linked to or recommended for the user, or other users to which they are connected. This may enable the staff member to promote products to the user which they are more likely to be interested in, increasing the likelihood of conversion.

According to an exemplary embodiment of the invention, there is provided method for delivering user information in-store, comprising the steps of: identifying the presence of a user in a store; delivering a user profile associated with the user to a device accessible by a staff member of the store.

In another embodiment, the user may be notified of stores within their vicinity supplying product associated with their account, or recommended for them or their friends. Such notifications may be sent or pushed to the user using any suitable means known in the art.

For a firmware and/or software (also known as a computer program) implementation, the techniques of the present invention may be implemented as instructions (for example, procedures, functions, and so on) that perform the functions described. It should be appreciated that the present invention is not described with reference to any particular programming languages, and that a variety of programming languages could be used to implement the present invention. The firmware and/or software codes may be stored in a memory, or embodied in any other processor readable medium, and executed by a processor or processors. The memory may be implemented within the processor or external to the processor.

A general purpose processor may be a microprocessor, but in the alternative, the processor may be any processor, controller, microcontroller, or state machine. A processor may also be implemented as a combination of computing devices, for example, a combination of a digital signal processor (DSP) and a microprocessor, a plurality of microprocessors, one or more microprocessors in conjunction with a DSP core, or any other such configuration. The processors may function in conjunction with servers and network connections as known in the art.

The steps of a method, process, or algorithm described in connection with the present invention may be embodied directly in hardware, in a software module executed by a processor, or in a combination of the two. The various steps or acts in a method or process may be performed in the order shown, or may be performed in another order. Additionally, one or more process or method steps may be omitted or one or more process or method steps may be added to the methods and processes. An additional step, block, or action may be added in the beginning, end, or intervening existing elements of the methods and processes.

### BRIEF DESCRIPTION OF DRAWINGS

Further aspects of the present invention will become apparent from the following description which is given by way of example only and with reference to the accompanying drawings in which:

FIG. 1A-C are block diagram illustrating an exemplary computer network system and components thereof in which embodiments of the present disclosure may be employed;

FIG. 2 is an illustration of an exemplary user home page of a product aggregation service;

FIG. 3 is a flow diagram illustrating an exemplary method for determining product recommendations, and

FIG. 4 is an exemplary form for recording product related activity against a user profile;

FIG. 5 is an illustration of an exemplary product page of a product aggregation service;

FIG. 6 is a flow diagram illustrating an exemplary method for requesting product reviews from a prior purchaser, and

FIG. 7 is an illustration of an exemplary user profile page of a product aggregation service;

FIG. 8 is an illustration of an exemplary retailer page of a product aggregation service;

FIG. 9 is a flow diagram illustrating an exemplary method for supplying search results;

FIG. 10 is an illustration of an exemplary user profile page of a product aggregation service;

FIG. 10 is an illustration of an exemplary product webpage from a retailer's online store;

FIG. 11 is a flow diagram illustrating an exemplary method of aggregating product related activity by a user;

FIG. 12A & B illustrate an exemplary product webpage;

FIG. 13 is a flow diagram illustrating an exemplary method of displaying a user profile on a user device, and

FIG. 14 is an illustration of an exemplary user interface displaying a user profile on a user device.

### DETAILED DESCRIPTION

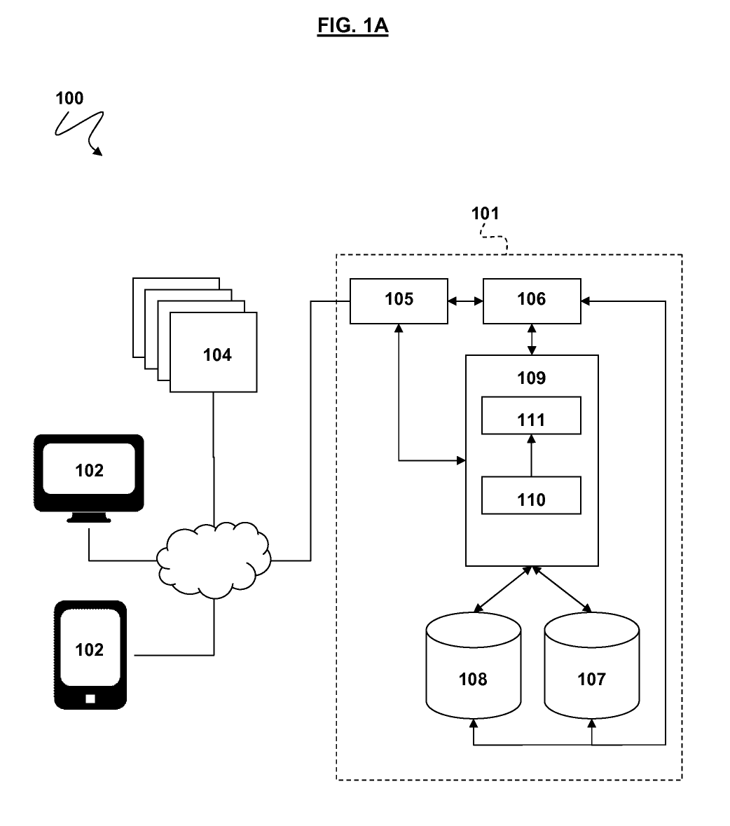

FIG. 1A illustrates a computer network environment 100 in which embodiments of the present invention may be implemented. A product aggregation system (“PA system”) 101 is provided, which can be accessed by users using any suitable user computing devices 102—for example a desktop or laptop computer, or a handheld device such as a mobile phone. The user devices 102 access the PA system 101 over a network 103, potentially comprising various configurations and protocols comprising the Internet, intranets, virtual private networks, wide area networks, local networks, private networks using communication protocols proprietary to one or more companies—whether wired or wireless, or a combination thereof. The PA system 101 and user devices 102 may also access, or be accessed by, e-commerce entity systems 104.

The PA system 101 may comprise one or more physical servers or computing machines. For example, the PA system 101 comprises one or more servers 105 for receiving, processing, and responding to requests from user devices 102. By way of example, the servers 105 could be web servers, application servers, database servers, or any other suitable type of server known in the art.

The server 105 can access information about data within PA system 101 via an access service 106. The access service 106 provides access to a product database 107 that stores information about products, retailers that sell them, and manufacturers or brands that produce them. The access service 106 can provide functionality for searching the product database 107

The access service 106 also provides access to a user database 108. The user database 108 stores information about users, for example, profile details, relationships between users, preferences, and details of product related activity.

The PA system 101 may also comprise a recommendation service 109 that assembles and provides the server 105 with details of one or more products a user may be interested in, based on their profile particularly purchases associated with their profile. The recommendation service 109 may comprise a user behaviour filter 110, and a recommendation engine 111.

FIG. 1B is a block diagram of server 105 is associated with a financial service provider, having a processor 112, memory 113, and other components typically present in such computing devices. In the exemplary embodiment illustrated the memory 113 stores information accessible by processor 112, the information comprising instructions 114 that may be executed by the processor 112 and data 115 that may be retrieved, manipulated or stored by the processor 112. The memory 113 may be of any suitable means known in the art, capable of storing information in a manner accessible by the processor, comprising a computer-readable medium, or other medium that stores data that may be read with the aid of an electronic device.

The processor 112 may be any suitable device known to a person skilled in the art. Although the processor 112 and memory 113 are illustrated as being within a single unit, it should be appreciated that this is not intended to be limiting, and that the functionality of each as herein described may be performed by multiple processors and memories, that may or may not be remote from each other.

The instructions 114 may comprise any set of instructions suitable for execution by the processor 112. For example, the instructions 114 may be stored as computer code on the computer-readable medium. The instructions may be stored in any suitable computer language or format.

Data 115 may be retrieved, stored or modified by processor 112 in accordance with the instructions 114. The data 115 may also be formatted in any suitable computer readable format. Again, while the data is illustrated as being contained at a single location, it should be appreciated that this is not intended to be limiting—the data may be stored in multiple memories or locations.

The instructions 114 may comprise directions for accessing and processing information from the access service 106, and in turn product database 107, user database 108, recommendation service 109, user behaviour filter 110, and recommendation engine 111. Conversely, those functions may be performed by the server 105 itself.

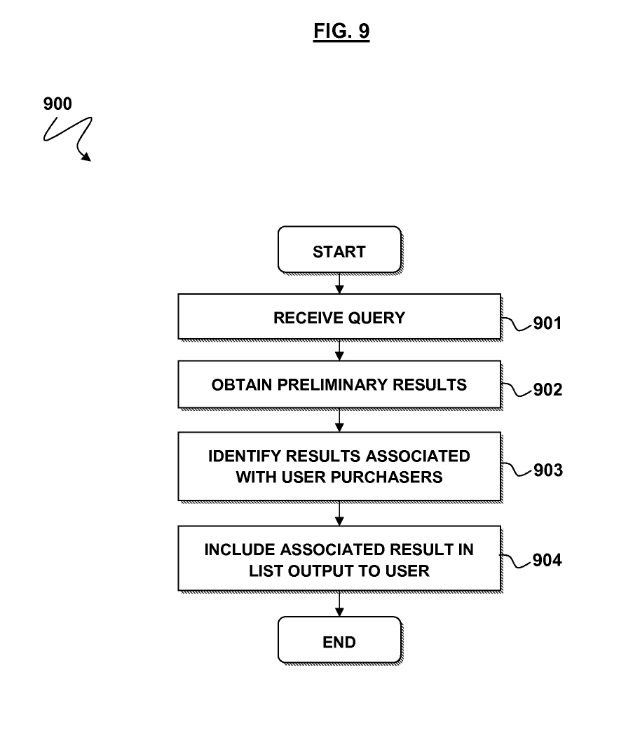

FIG. 1C is a block diagram of an exemplary user device 102 taking the form of a smartphone 116. It should be appreciated that the smartphone 116 may have more or fewer components than shown, may combine two or more components, or may have a different configuration or arrangement of the components. The various components shown in FIG. 10 may be implemented in hardware, software, or a combination of both hardware and software, comprising one or more signal processing and/or application specific integrated circuits.

The smartphone 116 comprises a memory 117 (which may comprise one or more computer readable storage mediums), one or more processing units (CPU's) 118, a speaker 119, a microphone 120, a battery 121, RF circuitry 122—the RF circuitry being capable of communication over mobile networks in addition to short range communication with other devices using the wireless technology standard known as Bluetooth®, as well known in the art—a GPS device 123, and a touch screen 124.

The one or more processors 118 run or execute various software programs and/or sets of instructions stored in memory 117 to perform various functions for the smartphone 116 and to process data. Software components stored in memory 117 may comprise an operating system and various modules or applications for controlling operation of the smartphone 116.

Operation of exemplary functions and operations of the PA system 101 will be described below.

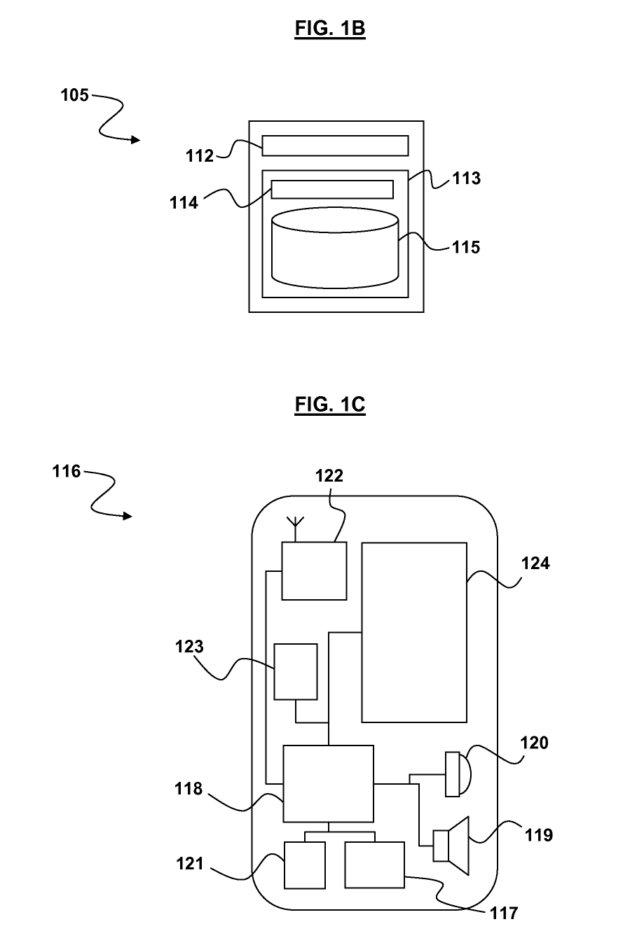

The PA system 101 may host a social network platform. FIG. 2 illustrates a user's home page 200 within that platform, which the user has logged into. The home page 200 comprises a recommendations section 201, comprising a series of recommended product identifiers 202 for products which have been recommended for the user by the recommendation service 109.

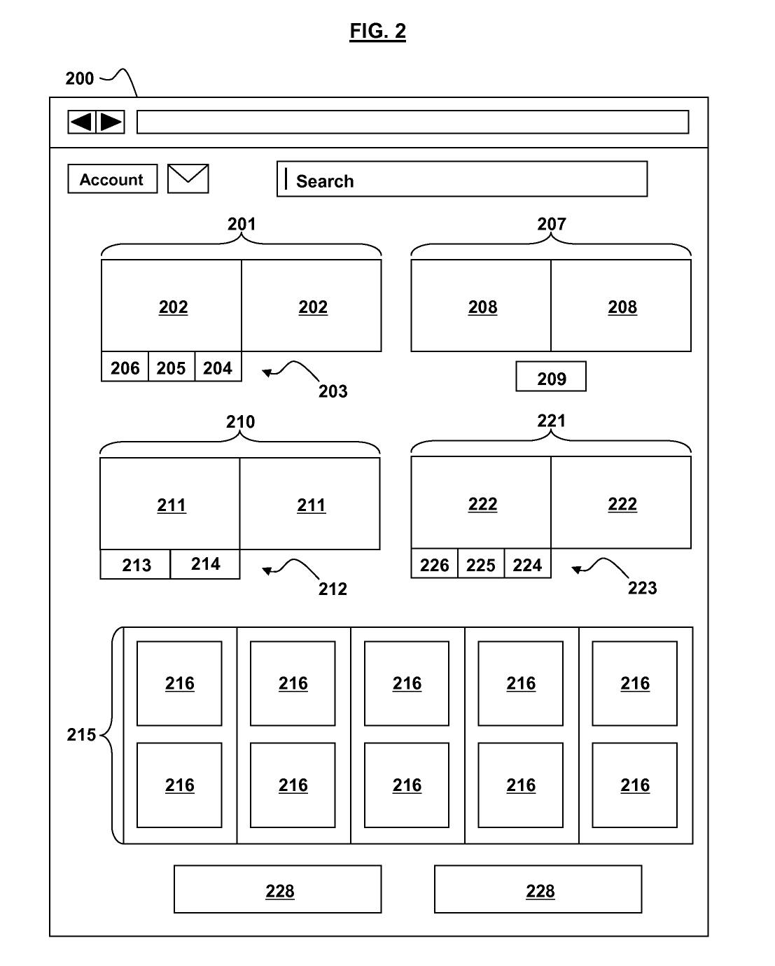

FIG. 3 illustrates an exemplary method 300 for determining the recommendations. In step 301 the user behaviour filter 110 of the recommendation service 109 obtains a list of products purchased for the user from user database 108. In step 302, the recommendation engine 111 creates a relevance multiplier for each product that equates to (a decay factor)̂(time since the product was purchased for the user).

In step 303 the recommendation engine 111 finds related products for each purchased product, and multiplies the relatedness factor by the relevance multiplier divided by the popularity of the related product. For related products suggested multiple times, the recommendation engine 111 adds the scaled relatedness factor together in step 304. In step 305 the related products are ranked by the summed and scaled relatedness factor to produce a list of recommendations.

Returning to home page 200 in FIG. 2, each product identifier 202 may display a recommendations options menu 203 (for example, permanently displayed, or on hovering over the identifier 202) having selectable tabs: “Got” 204, “Want” 205, and “No” 206.

Selection of the Got tab 204 registers in the user database 108 that the product has been purchased. A form may be triggered to enable the user to indicate the source of the purchase (whether a retailer or person), and whether the purchase was for another user. Selection of the Want tab 205 registers in the user database 108 that the product is of interest to the user, but has not been purchased. This information may be used to influence the relevance of products to the user when determining recommendations. Selection of the No tab 206 registers in the user database 108 that the product is not of interest to the user. Again, this information may be used to influence the relevance of products to the user when determining recommendations. If any of the selectable tabs 204, 205, 206 are selected, the associated product identifier 202 is removed from the recommendations section 201.

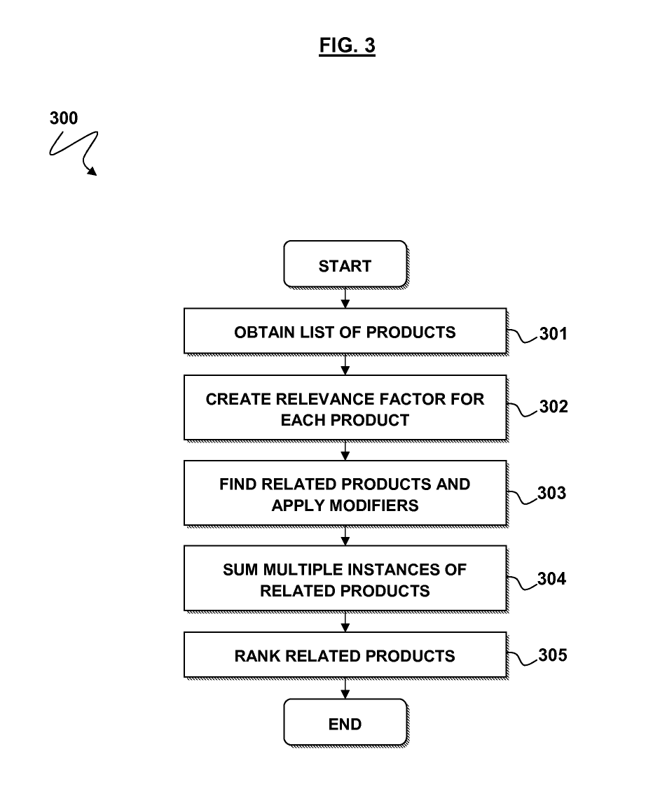

The home page 200 also comprises a purchased product section 207, comprising a series of purchased product identifiers 208 for products which have been purchased for the user. The purchased product section 207 comprises an “Add” option tab 209, selection of which opens exemplary purchase form 400 illustrated in FIG. 4.

The purchase form 400 comprises a series of information fields 401-414 as follows: name field 401, URL field 402, price field 403, image field 404, retailer field 405, recipient field 406, purchased for contact field 407, recipient identifier field 408, relationship field 409, purchaser field 410, purchaser contact field 411, purchaser identifier field 412, rating field 413, and review field 414. In each case, information may be suggested or autocompleted based on data stored in the product database 107 and/or user database 108.

In the event that either the recipient or the purchaser is not registered in the user database 108, a new user profile may be established for that person and linked to the user entering their details. Where contact information is provided (for example an email address or mobile phone number) an electronic message may be sent to invite the person to create an account with the PA system 101. If the user profile is not claimed, details associated with that profile may remain confidential to the creating user.

The home page 200 also comprises a wanted product section 210, displaying a series of wanted product identifiers 211 representing products which have been selected as being desired by the user (for example by selecting Want tab 205). Each product identifier 211 may display a wanted product options menu 212 having selectable Got tab 204 and No tab 206 as previously discussed.

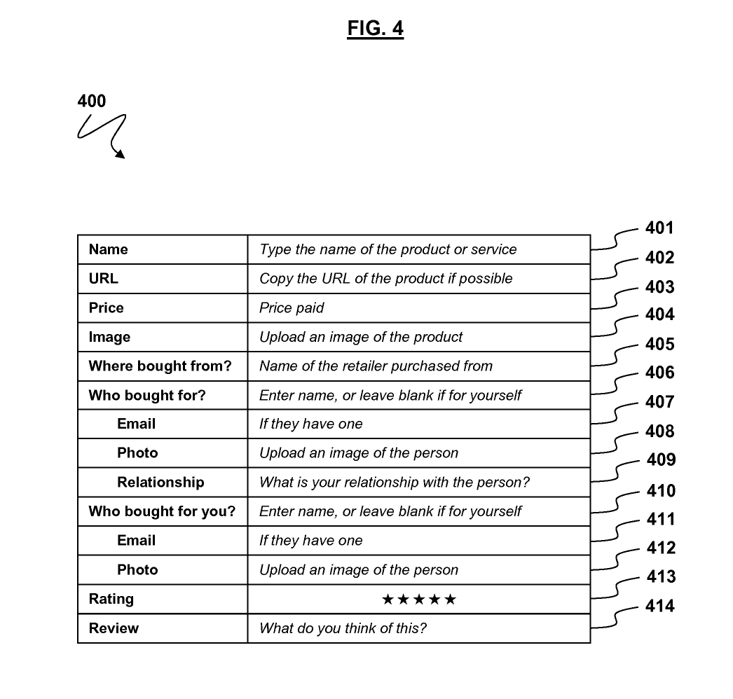

Selection of any of the product identifiers 202, 208, 211 may cause a product page 500 to be displayed, as illustrated in FIG. 5. The product page 500 displays meta information in the form of a product label 501, product image 502, and product description 503. Selectable Got 504 and Want 505 buttons may be provided, which function in a similar manner to the Got 204 and Want 205 tabs.

An associate retailer section 506 may also be displayed, comprising retailer identifiers 507 and retailer specific product price 508. A retailer specific purchase link 509 may be provided in order that the user may be directed to the retailer's online store to purchase the product. A product ratings 510 and product review link 511 may also be provided to assist the user in evaluating the product.

A related products section 512 may be provided, displaying a series of related product identifiers 513 relating to products which have been determined to be related to the main product on the page—for example accessories for the product. In embodiments, the related products may be compiled from a subset of products which are generally considered to be related (whether through purchase history of the general population or otherwise), and been ranked by the recommendation service 109 to specifically relate to the current user.

An alternative products section 514 may also be provided, displaying alternative product identifiers 515 representing products determined to be equivalent or similar to the main product of the page 500.

The product page 500 also comprises a related user purchase section 516, displaying purchaser identifiers, for example photograph 517, of users who have purchased the product. Users associated with the logged in user may be prioritised within the section 516. In the case of identifier 517, the user has provided a review 518 of the product. In contrast, the purchaser associated with purchaser identifier 519 has yet to provide a review for the product.

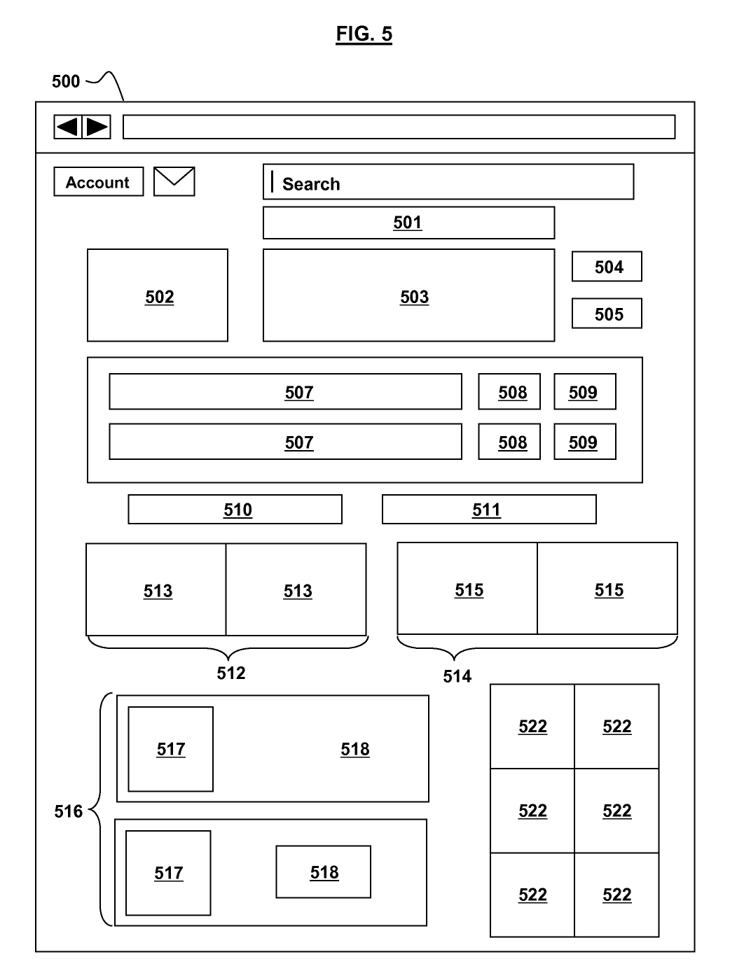

A review may be solicited by the current user in accordance with method 600 illustrated in FIG. 6. The previous purchaser of the product has previously been identified in user database 108 and their identifier 519 displayed on page 500 in step 601.

In step 602, selection of the review request button 520 causes a request to be lodged with PA system 101 for the purchaser associated with identifier 519 to supply a review of the product. In step 603 a message is sent to the purchaser notifying them of the request—for example via a notification 215 on their home page 200 (see FIG. 2), or an email to an associated account. A review may be received by the system 101 in step 604, for example via reply email or entry into a text field, and displayed on the product page 500 in step 605.

Returning to FIG. 5, the product page 500 may also comprise a related user want section 521, displaying user identifiers 522 of users who have previously indicated they “want” the product. Again, users associated with the currently logged in user may be given prominence.

Back at the user's homepage 200, a related user section 215 may display user identifiers for a range of associations with the current user, for example, identifiers 216 for people the user has purchased products for, identifiers 217 for people who have purchased products for the user, identifiers 218 for people the user has “followed” (as per social media outlets such as Twitter™ and Pintrest™ or other facilities), identifiers 219 for people following the user, and identifiers 220 for people suggested to the user as having similar preferences, for example they have bought or want similar products or have shopped at similar retailers.

An associated user purchases section 221 comprising associated user purchase identifiers 222 may be generally configured in the same manner as the other product display sections. A associated user purchases menu 223 may be provided with selectable Got 224, Want 225, and No 226 tabs may be provided, which function in a similar manner to the Got 204, Want 205, and No 206 tabs of the recommendations section 201.

Selection of a user identifier may result in different actions, depending on the relationship between the users. In the case of users for who the current user has established a profile (by virtue of having purchased product for them previously), and who have not taken control of that account, the current user may be presented with the ability to login to that profile or modify it directly. Alternatively, the home page 200 comprises an account option button 227, selection of which provides the user with details of their account and associated accounts, and options for managing same.

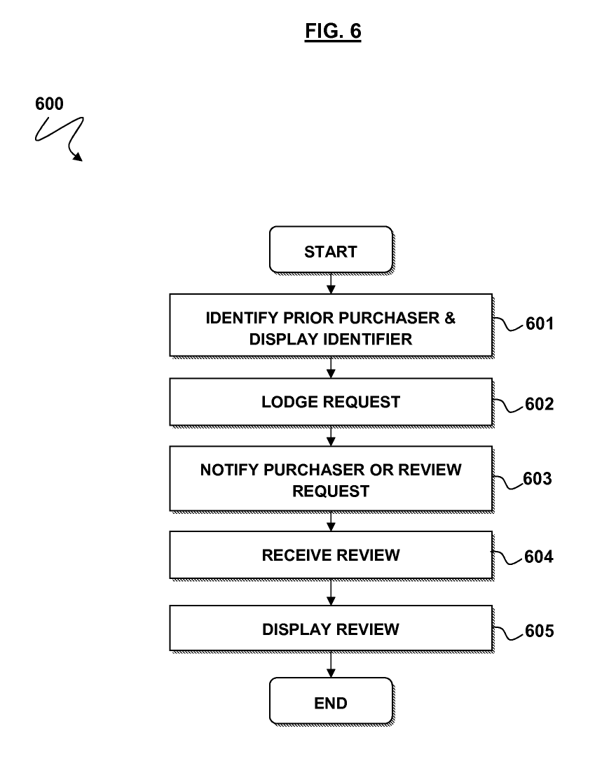

In other cases, it is envisaged that the user will be directed to the selected user's profile page 700, as illustrated in FIG. 7. The page 700 may comprise identifiers such as an avatar 701 and any details 702 the user wishes to be published such as name, location, demographics, etc.

Product display sections 704, 705, 706, and 707 corresponding to purchased product section 207, recommendation section 201, wanted product section 210, and associated user purchases menu 223 of the user's home page 200 may be comprised in page 700. The user may also be able to add products they have purchased for the selected user via an “Add” option tab 708 in a similar manner to tab 209 of home page 200. Further, the user may be able view the selected user's associations 709, and select their identifier to view additional user profiles.

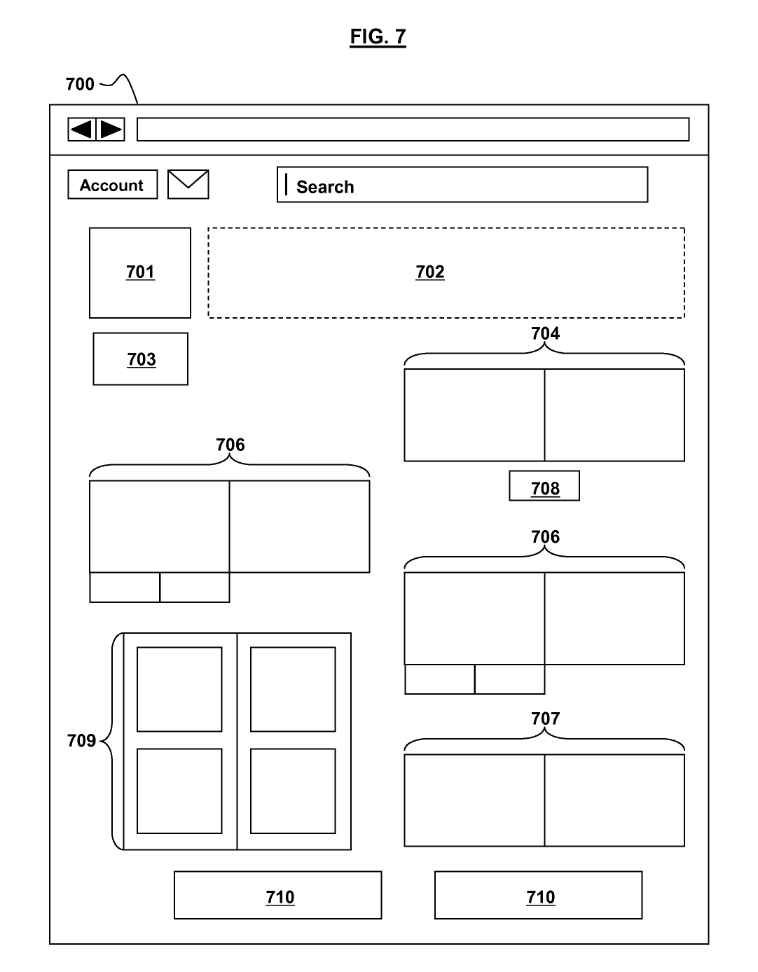

Each user's page 200, 700 may comprise links (228 and 710 respectively) to retailer pages hosted by the PA system 101. FIG. 8 illustrates an exemplary retailer page 800, comprising an identifier 801 (for example, name and logo), retailer description (comprising, for example physical store location, and URL for online store), an average rating indicator 803 for products sold by the retailer, and a review section link 804 to enable access to reviews of the retailer and its products.

The page 800 may comprise a retailer specific product recommendation section 805—generally functioning in a similar manner to recommendations section 201 of the user's home page 200. The page may also display a popular product section 806, with an individual rating 807 indicated for each product. Popularity may be determined across all purchases from the retailer—or specific to users associated with the logged in user. A retailer specific purchased product section 808 may also be provided, similar to purchased product section 207. Users who frequently purchase product from the retailer may be displayed 809. Again, users associated with the logged in user may be given prominence.

The page 800 may also comprise links 810 to related retailer pages—whether supplied by the retailer themselves, or as determined by the PA system 101 by monitoring browsing and purchasing activity.

Returning to the user's home page 200 of FIG. 2, the user may be provided with a search interface 229. The search interface 229 may enable the entry of search queries as known in the art, specific to products, users, retailers, or brands within the PA system 101. Such site searching functionality is known in the art, and results may be collected and returned in a variety of ways.

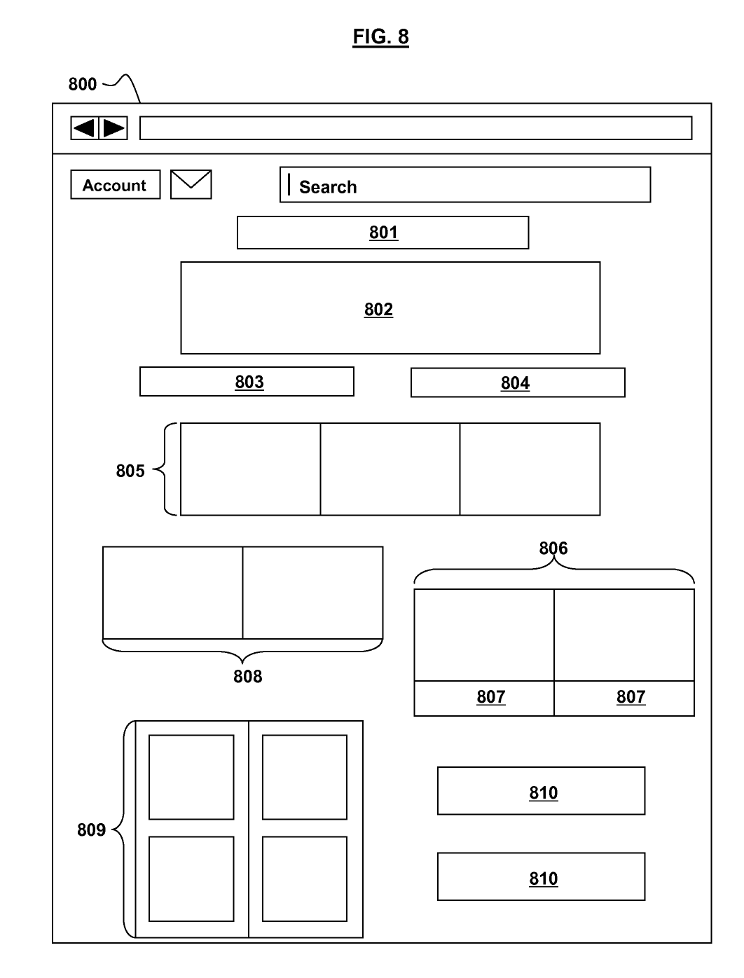

In one embodiment the search results to be delivered to the user are determined, at least in part, based on purchases made by other users with whom the current user is associated. Referring to FIG. 9, such a method 900 may comprise a number of steps. In step 901 the user's query is received by the access service 106, and in step 902 a preliminary set of search results is obtained from the product database 107 and user database 108 based on the query.

In step 903 the access service 106 identifies search results associated with purchases by other users associated with the user, shows a user identifier beside those purchases, and ensures that at least one of those associated search results is comprised in the list of search results output to the user in step 904. As previously discussed with the recommendations, the relevance of associated search results may influence their prominence—particularly in terms of where they rank within the results.

While various embodiments of the invention have been illustrated in the context of sites or pages hosted by the PA system 101, it should be appreciated that this is not intended to be limiting. For example, FIG. 10 illustrates a product webpage 1000 from a retailer's online store, accessed from a retailer system 104. The page 1000 displays product information 1001 such as price, description, and imagery, as known in the art.

The retailer system 104 may identify that the user is a member of the PA system 101 via browser identifiers, such as cookies, or a previous login, and page 1000 may also display content for that specific user via plugins linked to the PA system 101. For example, recommendations 1002 of other products sold by the retailer may be tailored to the user, and identifiers 1003 of other purchasers associated with the user may be displayed (also providing the review requesting functionality described above).

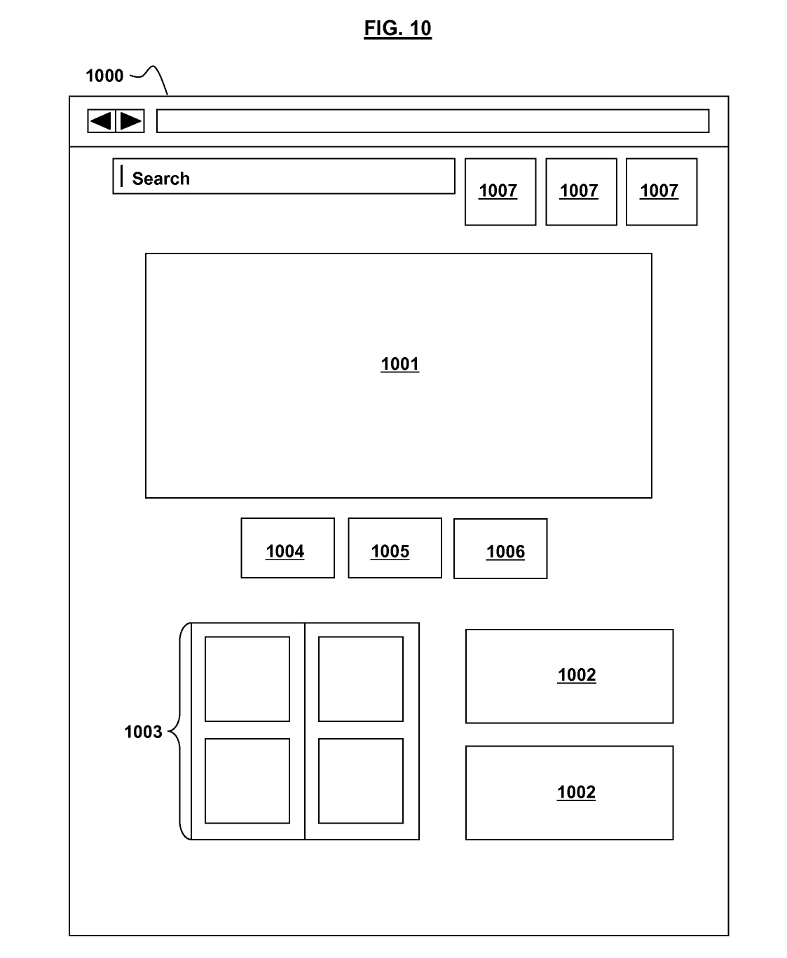

FIG. 11 illustrates a method 1100 of aggregating product related activity by a user of the PA system 101, and will be described with reference to FIG. 10. In step 1101, the user selects from “Purchase” option 1004 (which purchases the product), “Got” option 1005 (where the user already has the product), or “Want” option 1006 (where the product is one that the user desires. In step 1102, the selection is received by the PA system 101, and in step 1103 the product is associated with the user's profile in user database 108.

Returning to FIG. 10, where multiple user profiles are associated with the device 102 (and therefore browser identifier) accessing the page 1000, the PA system 101 may indicate the most likely profile based on the associations between the user profiles and the retailer, recent browsing or purchasing activity, or any other suitable means. In an exemplary embodiment, the page 1000 may be provided with selectable avatar icons 1007 to allow the user to select the currently active user profile. It should be appreciated that while FIG. 10 illustrates a retailer's product page, this is not intended to be limiting—the functionality described may be applied to other pages within the website.

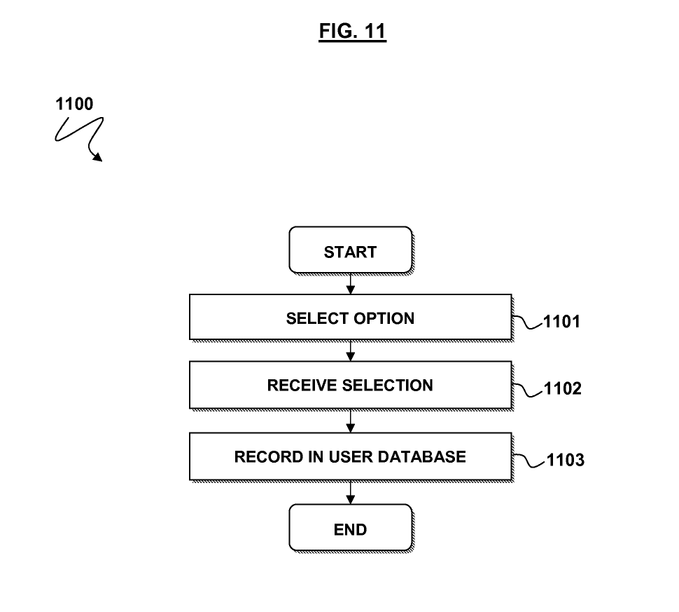

FIG. 12A illustrates a product webpage 1200 from a retailer's online store, which is not an active participant in the product aggregation service described. The page 1200 displays product information 1201 such as price, description, and imagery, as known in the art.

The user's browser has had a bookmarklet 1202 installed which interfaces with the PA system 101 to enable saving of product details to the PA system 101. Referring to FIG. 12B, the bookmarklet overlays the page 1200 with a product aggregation overlay 1203. The overlay 1203 presents a standardised overview of the products identified by the bookmarklet, comprising information gained from conducting a page scrape—such as image 1204 and price 1205.

The user is presented with a “Got” option 1206 and “Save” option 1207 for recording the product information in the user database 108 against the user's profile. The Save option 1207 provides the user with choices as to what grouping of product it is to be saved to—for example the “Want” grouping previously discussed, or a group created for a particular interest or friend of the user. Prior to transmission of the product data, the user may be given the opportunity to check the accuracy, or completeness of the page scrape.

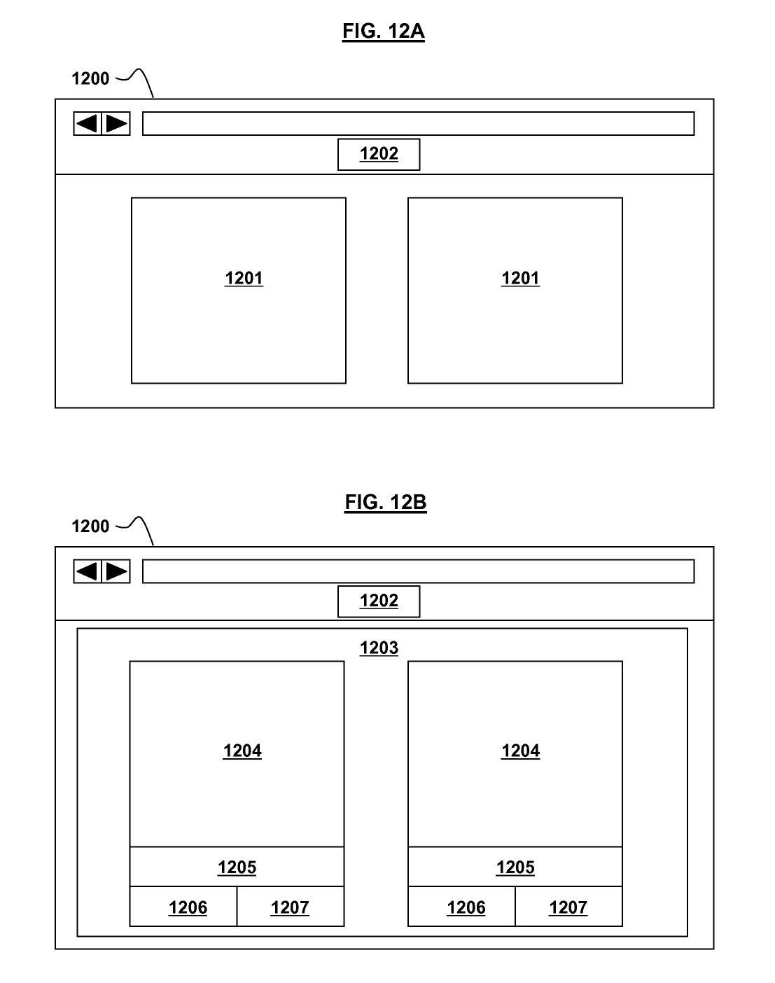

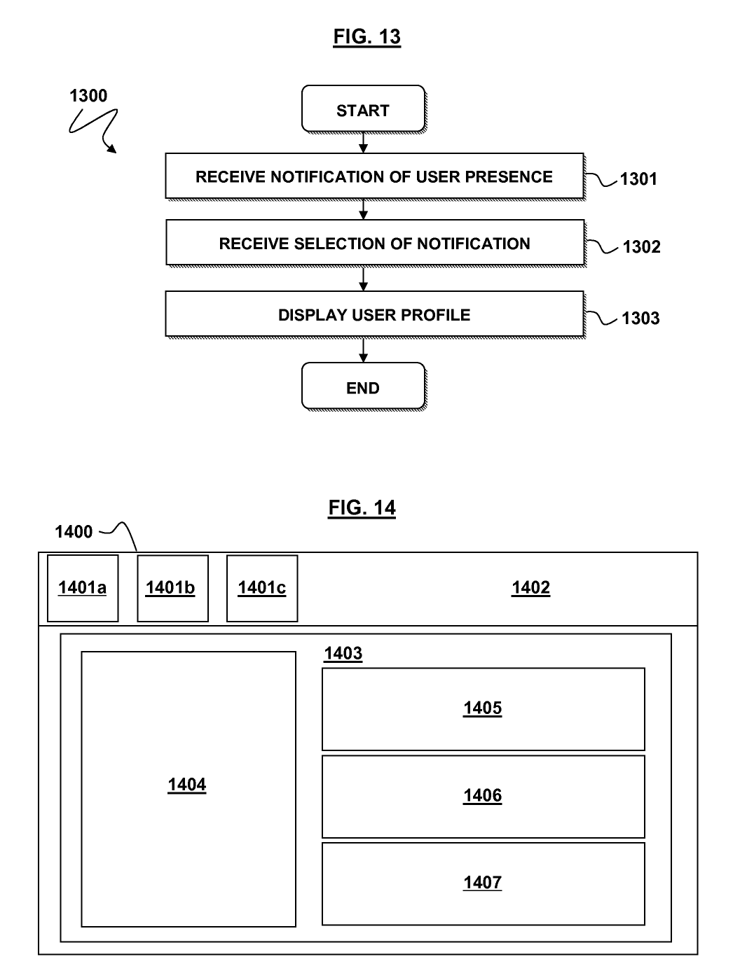

FIG. 13 illustrates an exemplary method 1300 of displaying a user profile on a user device of an e-commerce entity's associated physical presence—for example a retail store. Method 1300 will be described with reference to FIG. 14, which illustrates a user interface 1400 for display on a user device of the retail store—for example a desktop computer or tablet.

In step 1301, the user device receives a notification from the PA system 101 that a user is at least in the vicinity, if not in-store. It should be appreciate that the geo-location of a user may be established using any number of techniques—for example direct determination of GPS coordinates using GPS device 123 of smartphone 116, tracking of the smartphone 116 using network connections, or in conjunction with location “check-in” services such as Foursquare™.

Similarly, or simultaneously, the PA system 101 may issue a notification to the smartphone 116 to the user of stores in their vicinity having products of interest for sale, and details of same. These details may also be provided to the user at their request.

The notification issued to the user device of the store may be displayed in the form of a profile picture 1401, which may assist a staff member of the store in matching the user profile of a person entering the store. In the case of multiple user's being identified, multiple profile pictures 1401a, 1401b, 1401c may be displayed in a ribbon 1402 within the interface 1400.

On receiving selection of the profile picture 1401 in step 1302, a user profile 1403 is returned to, and displayed by, the user device. The profile 1403 comprises a user detail section 1404, providing details which the user has designated as being available for display in such circumstances—such as an enlarged user profile image and name.

The user profile 1403 also comprises a “want” section 1405 identifying products available from the store which the user has previously designated. A recommended product section 1406 comprises details of available products identified for the user by recommendation engine 111. The user profile may also comprise a connected user product section 1407, with details of available products linked to or recommended for other users to which they are connected.

According to an exemplary embodiment of the invention, there is provided method for delivering user information in-store, comprising the steps of: identifying the presence of a user in a store; delivering a user profile associated with the user to a device accessible by a staff member of the store.

In another embodiment, the user may be notified of stores within their vicinity supplying product associated with their account, or recommended for them or their friends. Such notifications may be sent or pushed to the user using any suitable means known in the art.

The entire disclosures of all applications, patents and publications cited above and below, if any, are herein incorporated by reference.

Reference to any prior art in this specification is not, and should not be taken as, an acknowledgement or any form of suggestion that that prior art forms part of the common general knowledge in the field of endeavour in any country in the world.

The invention of the present disclosure may also be said broadly to consist in the parts, elements and features referred to or indicated in the specification of the application, individually or collectively, in any or all combinations of two or more of said parts, elements or features.

Where in the foregoing description reference has been made to integers or components having known equivalents thereof, those integers are herein incorporated as if individually set forth.

It should be noted that various changes and modifications to the presently preferred embodiments described herein will be apparent to those skilled in the art. Such changes and modifications may be made without departing from the spirit and scope of the invention and without diminishing its attendant advantages. It is therefore intended that such changes and modifications be comprised within the present invention.

Aspects of the present invention have been described by way of example only and it should be appreciated that modifications and additions may be made thereto without departing from the scope thereof as defined in the appended claims.

1. A method of aggregating product related activity from across a plurality of e-commerce entities, comprising:
receiving, at a product aggregation service provider, data identifying a product at an e-commerce entity connected with activity by a user;
associating the product with at least one user profile maintained by the product aggregation service provider;
determining the geo-location of a user device being within the vicinity of a physical store location associated with the e-commerce entity; and
transmitting, to a user device of the store, at least a portion of the user profile of the user for display to a staff member of the store.

2. The method of claim 1, wherein the data identifying the product is input by the user into a user device.

3. The method of claim 1, wherein the data identifying the product is extracted from a purchase confirmation message issued to a purchaser and sent to the product aggregation service provider.

4. The method of claim 3, comprising identifying the at least one user profile based on at least one of sender details and destination details of the purchase confirmation message.

5. The method of claim 4, comprising identifying the user profile using an email address of the purchaser.

6. The method of claim 4, comprising identifying the user profile based on an email address of the product aggregation service provider to which the purchase confirmation message is sent.

7. The method of claim 1, comprising:
generating recommendations for the user profile based at least in part on products associated with the user profile; and
outputting the recommendations to the user associated with the user profile.

8. The method of claim 1, comprising:
identifying a user accessing an e-commerce entity website; and
determining a user profile maintained by the product aggregation service provider for the identified user.

9. The method of claim 8, wherein determining the user profile comprises presenting a plurality of user profiles for selection by the user.

10. The method of claim 1, comprising:
receiving a search query from a user;
determining search results in response to the search query;
identifying search results related to product associated with user profiles of other users associated with the user; and
comprising at least one of the search results related to product associated with user profiles of other users associated with the user in a list of search results output to the user.

11. The method of claim 1, comprising:
displaying a product webpage identifying a product for purchase;
determining previous purchasers of the product for purchase; and
displaying identifiers of the previous purchasers on the webpage.

12. The method of claim 11, comprising:
identifying a user viewing the product webpage; and
determining whether the identified user is associated with at least one of the previous purchasers of the product for purchase,
wherein displaying the identifiers comprises prioritising display of identifiers of the previous purchasers associated with the identified user.

13. The method of claim 11, comprising:
receiving, from a user, a request for a review of the product by at least one of the previous purchasers;
sending a message to the previous purchaser requesting a review of the product;
receiving the review from the previous purchaser; and
displaying the review.

14. The method of claim 13, wherein the review is supplied to at least one e-commerce entity displaying the product for purchase.

15. The method of claim 1, comprising:
determining proximity of the geo-location of the user to a physical presence of an e-commerce entity supplying product associated with their user profile.

16. The method of claim 15, further comprising notifying the user of stores within their vicinity supplying product associated with their user profile.

16. The method of claim 1, wherein displaying the user profile to the staff member comprises displaying details of products available from the store which are associated with the user.

19. A non-transitory computer readable storage medium storing one or more programs, the one or more programs comprising instructions, which when executed by at least one processor cause the processor to perform a method of aggregating product related activity from across a plurality of e-commerce entities, the instructions comprising:
instructions for receiving data identifying a product at an e-commerce entity connected with activity by a user; and
instructions for associating the product with at least one user profile maintained by a product aggregation service provider.

20. A system for aggregating product related activity from across a plurality of e-commerce entities, comprising at least one processor, and memory storing instructions which when executed by the processor cause the processor to perform a method of aggregating product related activity from across a plurality of e-commerce entities, comprising:
receiving data identifying a product at an e-commerce entity connected with activity by a user; and
associating the product with at least one user profile maintained by the product aggregation service provider;
determining the geo-location of a user device being within the vicinity of a physical store location associated with the e-commerce entity, and
transmitting, to a user device of the store, at least a portion of the user profile of the user for display to a staff member of the store.
